(19) United States
(12) Patent Application Publication
(10) Pub. No.: US 2020/0212462 A1
(43) Pub. Date: Jul. 2, 2020

(54) ELECTRICALLY DRIVEN COMPRESSOR

(71) Applicants: MAHLE International GmbH, Stuttgart (DE); MAHLE Filter Systems Japan Corporation, Tokyo (JP)

(72) Inventors: Naoto Morishita, Tokyo (JP); Masato Tsushima, Tokyo (JP)

(21) Appl. No.: 16/729,390

(22) Filed: Dec. 28, 2019

(30) Foreign Application Priority Data
Dec. 28, 2018 (JP) 2018-246667

(51) Int. Cl. H01M 8/04111; F04B 35/04

(52) U.S. Cl. CPC H01M 8/04111; H01M 2250/20; F04B 35/04

(57) ABSTRACT

An electrically driven compressor includes a rotating shaft, a pair of impellers mounted to the rotating shaft, an electric motor arranged between the individual impellers of the pair of impellers and configured to rotate the rotating shaft, primary bearings, one of which is arranged between one of the pair of impellers and the electric motor, the other of which is arranged between the other of the pair of impellers and the electric motor, the primary bearings being configured to rotatably support the rotating shaft, and a secondary bearing arranged on the side of an end of the rotating shaft relative to the primary bearing in a state where the secondary bearing has a gap with respect to a circumferential surface of the rotating shaft and is configured to be brought into contact with the rotating shaft and rotatably support the rotating shaft when whirling vibration occurs in the rotating shaft.

### CROSS REFERENCE TO RELATED APPLICATIONS

This application claims priority to Japanese patent application JP 2018-246667, filed Dec. 28, 2018, the entire content of which is incorporated herein by reference.

### TECHNICAL FIELD

The present disclosure relates to an electrically driven compressor.

### BACKGROUND

Conventionally, an electrically driven compressor of a centrifugal type is known as a supercharger that efficiently supplies compressed air that has been compressed by an impeller being rotated via a rotating shaft by an electrically driven motor. The electrically driven compressor has a rotating shaft, an impeller mounted to one end of the rotating shaft, an electrically driven motor that rotates the rotating shaft, and a bearing that rotatably supports the rotating shaft. In the electrically driven compressor, the electrically driven motor is provided in a housing (see, e.g., JP 2011-214523).

While it is possible to achieve both the high pressure and high flow rate of supply air by providing a pair of impellers on a rotating shaft, the total length of the rotating shaft becomes longer. As the rotating shaft becomes long, during operation of the electrically driven compressor, a whirling vibration of the rotating shaft in a centrifugal direction may occur on the side of the end of the rotating shaft relative to the bearing of the rotating shaft. In order to prevent the impeller from contacting the housing of the electrically driven compressor due to the whirling vibration of the rotating shaft in the centrifugal direction, countermeasures such as enlarging the diameter of the rotating shaft need to be implemented, and there has been room for improvement in reduction in the size as well as cost reduction of the device.

### SUMMARY

It is an object of the present disclosure to providing an electrically driven compressor which minimalizes the whirling vibration of a rotating shaft and having at least one pair of impellers in the centrifugal direction.

In accordance with an aspect of the present disclosure, an electrically driven compressor includes a rotating shaft, a pair of impellers mounted to the rotating shaft, an electric motor arranged between the individual impellers of the pair of impellers and configured to rotate the rotating shaft, primary bearings one of which is arranged between one of the pair of impellers and the electric motor and the other of which is arranged between the other of the pair of impellers and the electric motor, the primary bearings being configured to rotatably support the rotating shaft; and a secondary bearing arranged on the side of an end of the rotating shaft relative to the primary bearing in a state where the secondary bearing has a gap with respect to a circumferential surface of the rotating shaft and is configured to be brought into contact with the rotating shaft and rotatably support the rotating shaft when whirling vibration occurs in the rotating shaft. According to this aspect, during operation of the electrically driven compressor, in a case where a rotating shaft having at least one pair of impellers has reached its natural vibration range, the whirling vibrations of the rotating shaft on the side of the end of the rotation shaft relative to the primary bearing can be effectively suppressed. Further, the secondary bearing is capable of reducing, out of the natural vibration range of the rotating shaft, impact upon the rotation of the rotating shaft.

Also, the aforementioned secondary bearing may be arranged on the side of the end of the aforementioned rotating shaft relative to the aforementioned pair of impellers. According to this aspect, during operation of the electrically driven compressor, in a case where a rotating shaft having at least one pair of impellers has reached its natural vibration range, the whirling vibrations of the rotating shaft on the side of the end of the rotating shaft relative to the impeller can be effectively suppressed. By virtue of the above, contact of the impeller with any other constituent components of the electrically driven compressor can be prevented, the diameter of the rotating shaft can be suppressed, and reduction in the size of the device as well as cost reduction can be achieved.

Also, two or more pairs of impellers may be provided which are arranged at both ends of the aforementioned rotating shaft so as to be spaced apart from each other. According to this aspect, as a result of the fact that two or more pairs of impellers are provided, higher compression of air and higher flow rate can be achieved while suppressing the whirling vibration of the rotating shaft even when the inertia at the rotating shaft increases and the whirling vibration becomes significant in the centrifugal direction.

Also, the aforementioned secondary bearing may be provided between any two adjacent pairs of impellers out of the two or more pairs of impellers. According to this aspect, suppression is made possible to oscillations of the pair of impellers provided on the side of the end of the rotating shaft out of the two pairs of impellers due to the whirling vibrations of the rotating shaft.

Also, the aforementioned secondary bearing may be a dry-type bearing. According to this aspect, since lubricating oil does not need to be provided, improvement of service life of the electrically driven compressor can be achieved and complicated tasks associated with maintenance of lubrication can be eliminated, in addition to which diffusion of the oil components from the secondary bearing into the electrically driven compressor can be prevented.

Also, the electrically driven compressor according to the present disclosure may be an air compressor that supplies air to a fuel cell stack mounted on an automobile. In recent years, fuel-cell-powered automobiles have been developed from the perspective of carbon dioxide emission regulations and fuel regulations. In a fuel-cell-powered automobile, an electrically driven compressor is used to take in air containing oxygen, compress it, and supercharge the fuel cell stack. Among such electrically driven compressors, an air compressor may be found in which pairs of impellers are coaxially arranged at both ends of a rotating shaft of an electric motor. According to this aspect, supply of the compressed oxygen to the fuel cell stack can be stably performed, and damage to the electrically driven compressor and accidental stoppage associated therewith of traveling of the automobile can be avoided.

### EFFECTS OF THE INVENTION

According to the present disclosure, the whirling vibration of the rotating shaft having at least one pair of impellers in the centrifugal direction can be minimized.

### BRIEF DESCRIPTION OF THE DRAWINGS

The disclosure will now be described with reference to the drawings wherein:

FIG. 1 is a cross-sectional view of an electrically driven compressor taken along the line of the rotating shaft according to an exemplary embodiment of the present disclosure; and

FIG. 2 is an enlarged view depicting a zoomed-in view of one end side of a rotating shaft of the electrically driven compressor according to an exemplary embodiment of the present disclosure.

### DESCRIPTION OF EXEMPLARY EMBODIMENTS

An exemplary embodiment of the present disclosure will be described with reference to the drawings.

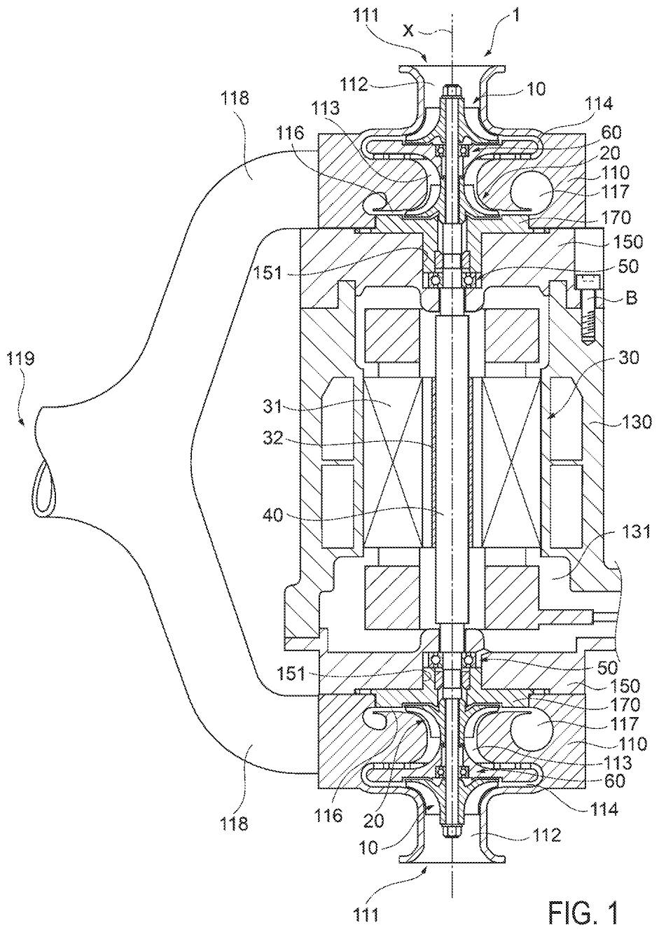

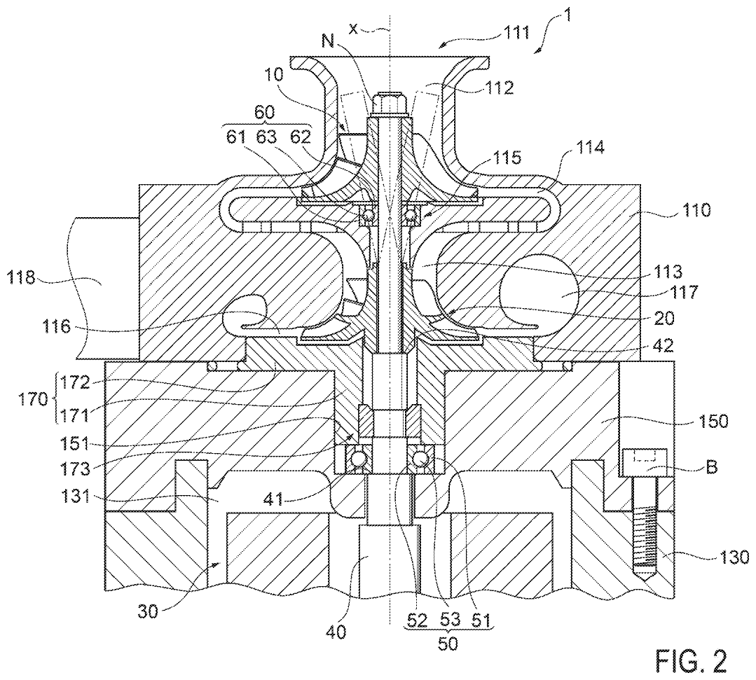

The electrically driven compressor according to an exemplary embodiment of the present disclosure is used as an air compressor, which is an auxiliary machine of a fuel cell stack mounted on a fuel-cell-powered automobile. The air compressor supplies the air serving as an oxidant to the fuel cell stack (target of supercharging). FIG. 1 is a cross-sectional view of the electrically driven compressor 1 according to the present disclosure taken along the rotation axis line x. FIG. 2 is an enlarged view which depicts a zoomed-in view of the one end side of the rotating shaft 40 of the electrically driven compressor 1.

The electrically driven compressor 1 according to the exemplary embodiment of the present disclosure includes two sets of a pair of impellers 10:20, an electrically driven motor (electric motor) 30, a rotating shaft 40, a pair of primary bearings 50, and a pair of secondary bearings 60. The two sets of a pair of impellers 10:20 are mounted on the rotating shaft 40 such that they do not rotate relative to each other. The electrically driven motor 30 is arranged between the pairs of impellers 10:20. The electrically driven motor 30 is configured to rotate the rotating shaft 40. The primary bearings 50 are respectively arranged between the individual impellers of the pair of impellers 10:20 and the electrically driven motor 30. The primary bearings 50 are configured to rotatably support the rotating shaft 40. The secondary bearings 60 are arranged on the side of the end of the rotating shaft 40 relative to the primary bearings 50 in a state where they are spaced apart from the circumferential surface of the rotating shaft 40. The secondary bearings 60 are configured to be brought into contact with the rotating shaft 40 when whirling vibration occurs in the rotating shaft 40 so as to rotatably support the rotating shaft 40. Hereinafter the electrically driven compressor 1 will be specifically described.

The electrically driven compressor 1 according to an exemplary embodiment of the present disclosure is a centrifugal type compressor with a two-stage-type impeller structure that has two pairs of impellers 10:20 at both ends of the rotating shaft 40. The impellers 10, 20, the electrically driven motor 30, the rotating shaft 40, the primary bearings 50, and the secondary bearings 60 of the electrically driven compressor 1 are accommodated in a housing. The housing has a pair of compressor housings 110 and a motor housing 130.

The pair of compressor housings 110 are respectively provided at both ends of the motor housing 130 along the rotation axis line x of the electrically driven motor 30. The motor housing 130 is located between the pair of compressor housings 110 and is formed in a substantially cylindrical shape. The motor housing 130 has a motor chamber 131. Between the compressor housing 110 and the motor housing 130, disc-like end plates 150 are respectively provided. The compressor housings 110 and the motor housing 130 are coupled to each other via the end plates 150 by a plurality of bolts B.

The pair of compressor housings 110 each have an intake port 111, a first chamber 112, and a second chamber 113. The first chamber 112 is provided on the side of the intake port 111 relative to the second chamber 113. The intake port 111 is provided at an end face of the compressor housing 110, where the end face is oriented outward in the rotation axis line x. The intake port 111 is an inlet for introducing air from the outside into the electrically driven compressor 1. The intake port 111 is formed as a cylindrical portion protruding from the compressor housing 110 in the rotation axis line x.

The first chamber 112 has a feeding flow channel 114 and a penetrating recessed section 115. The feeding flow channel 114 compresses the air pressurized by the impeller 10 to a required pressure and guides it to the second chamber 113. The feeding flow channel 114 is formed on the outer circumferential side of the impeller 10. The penetrating recessed section 115 is formed coaxially with the rotation axis line x. The penetrating recessed section 115 is formed to be concave from the side of the end plate 150 facing the intake port 111 toward the side of the electrically driven motor 30. The rotating shaft 40 is inserted into the penetrating recessed section 115. An opening in the penetrating recessed section 115 on the side facing the electrically driven motor 30 is configured to be smaller than an opening in the penetrating recessed section 115 on the side facing the intake port 111. The secondary bearing 60 is accommodated in the penetrating recessed section 115 and is supported on the side of the electrically driven motor 30.

The second chamber 113 has a ring-like diffuser section 116 and a scroll section 117. The diffuser section 116 and the scroll section 117 are provided around the second chamber 113 in the compressor housing 110 about the rotation axis line x. The diffuser section 116 is a flow channel that extends from the outer circumferential portion of the impeller 20 and reaches the scroll section 117. The diffuser section 116 is configured as a vaneless-type diffuser formed with two parallel wall surfaces intersecting the rotation axis line x of the rotating shaft 40.

Each compressor housing 110 is connected to an outlet pipe 118 in a plane intersecting the rotation axis line x. The individual outlet pipes 118 merge on the downstream side in the flow direction of the compressed air fed to the target of supercharging and are respectively in communication with the discharge port 119.

The end plate 150 has a penetrating recessed section 151. The penetrating recessed section 151 is formed coaxially with the rotation axis line x. The penetrating recessed section 151 is formed to be concave from the side of the end plate 150 facing the intake port 111 toward the side of the electrically driven motor 30. The rotating shaft 40 is inserted into the penetrating recessed section 151. The opening in the penetrating recessed section 151 facing the electrically driven motor 30 is smaller than the opening on the side of the penetrating recessed section 151 facing the intake port 111. The primary bearing 50 is accommodated in the penetrating recessed section 151 and supported on the side of the electrically driven motor 30.

The impeller 10 is provided in the first chamber 112 of the compressor housing 110. The impellers 10 are symmetrically mounted to the rotating shaft 40 such that they are oriented in opposite directions from each other. The impellers 20 are provided in the second chamber 113 of the compressor housing 110. The impellers 20 are symmetrically mounted on the rotating shaft 40 such that they are oriented in opposite directions from each other. The impellers 10:20 compress the air taken from the outside.

The pair of impellers 10 is a first impeller (the air compressor of the first stage) that compresses the air taken from the outside to about half of the required pressure. The pair of impellers 20 is a second impeller (the air compressor of the second stage) that compresses the air that has been compressed by the first impeller 10 to a required pressure. The second impeller 20 is located on the downstream side of the inflow direction of the air relative to the first impeller 10.

The first impellers 10 are respectively located at both ends of the rotating shaft 40. The first impeller 10 extends so as to reach the cylindrical portion of the intake port 111. The first impeller 10 has a plurality of blades. The blades compress the air that has been taken in via the intake port 111 in the rotation axis line x to about a half of the required pressure and supplies it toward the outer circumferential side in the radial direction. The blades are twisted in a helical shape. As the shape of a rotating body defined by the outer edges of the blades, the first impeller 10 defines a generally frustoconical shape.

The second impeller 20 is located in the rotating shaft 40 on the side of the electrically driven motor 30 relative to the first impeller 10. The second impeller 20 is accommodated in the second chamber 113. The second impeller 20 has a plurality of blades. The blades further compress the air compressed by and fed from the first impeller 10 and supplies it to the subject of supercharging. The blades are twisted in a helical shape. As the shape of a rotating body defined by the outer edges of the blades, the second impeller 20 defines a generally frustoconical shape.

The electrically driven motor 30 is provided in the motor chamber 131 of the motor housing 130. The electrically driven motor 30 rotates the rotating shaft 40 to rotate at high speed the first impeller 10 and the second impeller 20 mounted on the rotating shaft 40. The electrically driven motor 30 has a stator 31 and a permanent magnet 32. The stator 31 is provided such that it is placed in fitting engagement with the inner circumference of the motor housing 130. The stator 31 has a stator coil (not shown). The permanent magnet 32 is a rotor mounted on the outer circumferential surface of the rotating shaft 40. The outer circumferential surface of the permanent magnet 32 and the inner circumferential surface of the stator 31 face each other with a slight gap (air gap) in between.

The rotating shaft 40 couples the first impeller 10, the second impeller 20, and the electrically driven motor 30 to each other. The rotating shaft 40 are rotatably supported by the pair of end plate 150 respectively via the primary bearings 50. The rotating shaft 40 is tapered from the central portion to both ends. External threads (not shown) are formed at both ends of the rotating shaft 40. Since the nut N is fastened to the external thread, the first impeller 10 does not fall off the rotating shaft 40.

The rotating shaft 40 has a pair of bearing step portions 41 and a pair of impeller step portions 42. The bearing step portion 41 is located on the side of the electrically driven motor 30 relative to the impeller step portion 42. The bearing step portion 41 is a portion that is made slightly larger than the diameter on the side of the end of the rotating shaft 40 from the bearing step portion 41. The bearing step portion 41 supports the primary bearing 50 from the side of the electrically driven motor 30. The impeller step portion 42 is a portion that is made larger than the diameter on the side of the end of the rotating shaft 40 from the impeller step portion 42. The impeller step portion 42 supports the second impeller 20 from the side of the electrically driven motor 30.

The primary bearing 50 is formed as a ball bearing and may be formed by bearing steel or martensitic stainless steel. The primary bearing 50 has an outer ring 51, an inner ring 52, and a plurality of rolling elements 53. A rotating shaft 40 is inserted in the inner ring 52. The center line of the inner ring 52 coincides with the rotation axis line x of the rotating shaft 40. The rotating shaft 40 is placed in rotatable contact with the inner circumferential surface of the inner ring 52. A concave track surface is formed in the outer circumferential surface of the inner ring 52. The rolling elements 53 have a spherical shape. The rolling elements 53 are in contact with the track surfaces of the outer ring 51 and the inner ring 52. The primary bearing 50 is in fitting engagement with the inner circumferential surface of the penetrating recessed section 151 of the end plate 150 in the outer ring 51. The penetrating recessed section 151 is closed by the cover member 170.

The cover member 170 has a cylindrical portion 171 and a flange section 172. The cylindrical portion 171 is inserted into the penetrating recessed section 151 of the end plate 150 with a gap created with respect to the rotating shaft 40. With regard to the cylindrical portion 171, its outer circumferential surface is in contact with the inner circumferential surface of the penetrating recessed section 151. A labyrinth seal 173 is provided between the cylindrical portion 171 and the rotating shaft 40. The labyrinth seal 173 is provided on the side near the primary bearing 50. The labyrinth seal 173 prevents the lubricating oil of the primary bearing 50 from moving to the side of the first impeller 10 and the second impeller 20. The flange section 172 is provided at the end of the cylindrical portion 171 opposite to the primary bearing 50. The flange section 172 extends in a ring-like fashion from the cylindrical portion 171 outward in the radial direction. The cover member 170 is sandwiched, at the flange section 172, between the end plate 150 and the compressor housing 110.

In order to supply compressed air having a higher pressure to the subject of supercharging, the electrically driven compressor 1 has two pairs of impellers 10:20. In the electrically driven compressor 1, since the quantities of flow to the individual pairs of the impellers 10:20 can be halved, as compared with cases in which only a single stage is present, reduction in the size (diameter) of the impeller 10:20 can be achieved. By virtue of this, the moment of inertia at the impellers 10:20 can be reduced and excellent responsiveness can be obtained in the electrically driven compressor 1.

However, the rotating shaft 40 needs to be lengthened in response to the increased stages of the impellers 10:20. When the total length of the rotating shaft 40 is extended, the rotating shaft 40 may cause severe lateral vibration when operated at a predetermined rotation speed or within a predetermined range of the rotation speed during the operation of the electrically driven compressor 1. This phenomenon is a whirling vibration of the rotating shaft 40, in which the oscillations of the rotating shaft 40 in the centrifugal direction become substantial.

It has been found that the natural vibration range of the rotating shaft 40 resides in the low rotation range during operation of the electrically driven compressor 1. Since the electrically driven compressor 1 is, in normal cases, used in a high rotation range, the period during which the rotating shaft 40 is used in a low rotation range is extremely short. However, the electrically driven compressor 1 should always go through the low rotation range at the time of start and stoppage of the electrically driven compressor 1.

The rotating shaft 40 is always rotatably supported by the primary bearing 50 between the second impeller 20 and the electrically driven motor 30. Accordingly, even in a case where the natural vibration range of the rotating shaft 40 is reached, the whirling vibrations of the rotating shaft 40 are suppressed between the second impeller 20 and the electrically driven motor 30.

In contrast, the first impeller 10 is provided on the side of the end of the rotating shaft 40 relative to the second impeller 20. Since the side of the end of the rotating shaft 40 relative to the primary bearing 50 is a free end, in particular, the first impeller 10 is exposed to large whirling vibrations when the electrically driven compressor 1 goes through the low rotation range. It may be contemplated to suppress the whirling vibrations of the rotating shaft 40 (to shift the natural vibration range) through enlarging the diameter of the rotating shaft 40 to enhance its rigidity. However, in response to the increase in the diameter of the rotating shaft 40, the moment of inertia of the rotating shaft 40 will also increase. In a possible case where the bearing is arranged on the side of the end of the rotating shaft 40 relative to the two pairs of impellers 10:20, the member for supporting the bearing needs to be arranged at the intake port 111. However, the introduction of air into the first impeller 10 may be influenced by this member. In view of this, through intensive study by the inventors of the present disclosure, it has been revealed that it is of significance, in terms of suppression of the whirling vibrations of the rotating shaft 40, to provide a secondary bearing 60 on the rotating shaft 40 between the first impeller 10 and the second impeller 20. According to this aspect, appropriately arranging the secondary bearing 60 while suppressing the impact on the introduction of air to the impellers is made possible.

The secondary bearing 60 is configured as a touchdown bearing. The rotating shaft 40 is inserted into the secondary bearing 60. The center line of the secondary bearing 60 coincides with the rotation axis line x. The secondary bearing 60 has an outer ring 61, an inner ring 62, and a plurality of rolling elements 63.

The outer ring 61 is press-fitted into the inner circumferential surface of the penetrating recessed section 115 of the compressor housing 110. A concave track surface is formed in the inner circumferential surface of the outer ring 61.

A rotating shaft 40 is inserted into the inner ring 62. The center line of the inner ring 62 coincides with the rotation axis line x of the rotating shaft 40. During the normal operation of the electrically driven compressor 1 (where whirling vibration does not occur in the rotating shaft 40), a gap in the radial direction is created between the inner circumferential surface of the inner ring 62 and the outer circumferential surface of the rotating shaft 40. The gap between the inner ring 62 and the outer circumferential surface of the rotating shaft 40 is 20 to 50 μm. A concave track surface is formed in the outer circumferential surface of the inner ring 62.

The rolling elements 63 have a spherical shape. The rolling elements 63 are in contact with the track surfaces of the outer ring 61 and the inner ring 62.

According to the electrically driven compressor 1 described in the foregoing, in a case where the natural vibration range of the rotating shaft 40 has been reached during the operation and whirling vibration occurs in the rotating shaft 40 on the side of the first impeller 10 (which is indicated by broken lines (see FIG. 2)), the rotating shaft 40 is configured to be brought into contact with the inner ring 62 of the secondary bearing 60. By virtue of this, the rotating shaft 40 is rotatably supported by the secondary bearing 60 and thereby the whirling vibrations are suppressed. Due to the fact that the whirling vibration is suppressed, the compressed oxygen (compressed air) to the fuel cell stack can be stably supplied.

Further, the secondary bearing 60 is provided with a gap created with respect to the rotating shaft 40 after the natural vibration range of the rotating shaft 40 has been exceeded. The period of contact between the secondary bearing 60 and the rotating shaft 40 is limited within the period of operation of the electrically driven compressor 1, and, during normal operation, the rotating shaft 40 and the secondary bearing 60 do not contact one another. As a result, the secondary bearing 60 is configured as a dry-type bearing that does not require lubricating oil. Accordingly, no leakage of oil components occurs out of the secondary bearing 60 and there is no concern that oil components may enter a fuel cell stack, which is often the case when using a conventional bearing of a lubricant-enclosed type.

### Others

Whilst the exemplary embodiment of the present disclosure has been described in the foregoing, the present disclosure is not limited to the above-described exemplary embodiment, and encompasses all aspects that may be included in the concept of the present disclosure as well as the scope of the claims. Also, the individual features may be selectively combined as appropriate so as to achieve at least part of the technical aspects and/or effects which have been discussed in the foregoing. In addition, for example, the shape, material, arrangement, size, and the like of each constituent feature in the above-described embodiment can be modified as appropriate according to the specific modes of usage of the present disclosure.

In the above-described exemplary embodiment, the electrically driven compressor 1 is a centrifugal type compressor with a two-stage-type impeller structure, but the structure of the twin impellers is not limited to this, and they may have a single-stage configuration or any configuration of three or more stages.

Also, in the above-described embodiment, the electrically driven compressor 1 has a twin impeller structure, but it may also have a structure including the impellers only at one end of the rotating shaft 40. In this case, the impellers may be provided at a single stage or multiple stages.

Thus, it is understood that the foregoing description is that of the exemplary embodiments of the invention and that various changes and modifications may be made thereto without departing from the spirit and scope of the invention as defined in the appended claims.

What is claimed is:

1. An electrically driven compressor comprising:
a rotating shaft;
a pair of impellers mounted to the rotating shaft;
an electric motor arranged between the individual impellers of the pair of impellers and configured to rotate the rotating shaft;
primary bearings, one of which is arranged between one of the pair of impellers and the electric motor, and the other of which is arranged between the other pair of impellers and the electric motor, the primary bearings being configured to rotatably support the rotating shaft; and
a secondary bearing arranged on the side of an end of the rotating shaft relative to a primary bearing in a state, the secondary bearing having a gap with respect to a circumferential surface of the rotating shaft and being configured to be brought into contact with the rotating shaft and rotatably support the rotating shaft when whirling vibration occurs in the rotating shaft.

2. The electrically driven compressor according to claim 1, wherein the secondary bearing is arranged on the side of the end of the rotating shaft relative to the pair of impellers.

3. The electrically driven compressor according to claim 1, wherein two or more pairs of impellers that are arranged to be spaced apart from each other are provided at both ends of the rotating shaft.

4. The electrically driven compressor according to claim 3, wherein the secondary bearing is provided between any two adjacent pairs of impellers out of the two or more pairs of impellers.

5. The electrically driven compressor according to claim 1, wherein the secondary bearing is a dry-type bearing.

6. The electrically driven compressor according to claim 1, wherein the electrically driven compressor is an air compressor supplying air as an oxidant to a fuel cell stack mounted on an automobile.
